(19) United States
(12) Patent Application Publication
(10) Pub. No.: US 2013/0257009 A1
(43) Pub. Date: Oct. 3, 2013

(54) Adjustable Wheelbase Wheelchair

(71) Applicant: Richard H. Rogers, San Antonio, TX (US)

(72) Inventor: Richard H. Rogers, San Antonio, TX (US)

(73) Assignee: ActivX Mobility

(21) Appl. No.: 13/437,666

(22) Filed: Apr. 2, 2012

(51) Int. Cl. A61G 5/08; B62B 3/02

(52) U.S. Cl. 280/250.1; 280/639

(57) ABSTRACT

A wheelchair chassis may include a first and second side frame positioned substantially parallel to and at a width apart from one another. The chassis may also include a first and second receiver tube positioned substantially parallel to and coupled to the first and second side frames, respectively. The chassis may additionally include a first and second extension tube telescopically engaged with the first and second receiver tubes, respectively. The chassis may further include a first and second cross member, with the first cross member pivotally coupled to the first receiver tube and the second extension tube and the second cross member pivotally coupled to the second receiver tube and the first extension tube. The second cross member may be engaged to the first cross member in an X-shaped configuration disposed horizontally between the side frames, where the second cross member is substantially co-planar with the first cross member.

### TECHNICAL FIELD

The present invention relates to wheelchairs and other wheeled apparatuses.

### BACKGROUND

Because wheelchairs must have a high degree of stability when their users traverse sloped surfaces or effect rapid turns, traditional wheelchairs with fixed wheelbase dimensions are designed with suitably large wheelbase dimensions. But a wheelchair with fixed wheelbase dimensions is an impediment to wheelchair users in many contexts. For example, maneuvering into small washrooms, around cramped office quarters, and through the interior doors of most homes is often impossible. Additionally, standard wheelchairs with a large, fixed wheelbase dimension will not ordinarily pass down an airliner aisle. As a result, the user must necessarily transfer from a traditional fixed wheelbase wheelchair to one of the airline's uncomfortable and humiliating “people dollies.”

Attempts have been made to address these problems by developing wheelchairs with an adjustable wheelbase, but such wheelchairs enable only incremental and semi-permanent adjustments, not the type of ad hoc, easily reversible, on-the-fly adjustments which are necessary when dealing with obstacles which can only be, or can more easily be, traversed by a wheelchair with a narrower wheelbase.

### SUMMARY OF THE INVENTION

In accordance with the teachings of the present disclosure, the disadvantages and problems associated with traditional fixed wheelbase wheelchairs have been substantially reduced or eliminated.

In embodiments of the present disclosure, an apparatus for use as a wheelchair chassis may include a first side frame and a second side frame. The second side frame may be positioned substantially parallel to the first side frame at a width apart from the first side frame. The apparatus may also include a first receiver tube, which may be positioned substantially parallel to the first side frame and coupled to the first side frame, as well as a second receiver tube, which may be positioned substantially parallel to the second side frame and coupled to the second side frame. The apparatus may additionally include a first extension tube, which may be telescopically engaged with the first receiver tube, and a second extension tube, which may be telescopically engaged with the second receiver tube. The apparatus may further include a first cross member, which may be pivotally coupled to the first receiver tube and the second extension tube, as well as a second cross member, which may be pivotally coupled to the second receiver tube and the first extension tube.

Additionally, the second cross member may be engaged to the first cross member in an X-shaped configuration disposed horizontally between the first side frame and the second side frame, where the second cross member is substantially co-planar with the first cross member.

In these and other embodiments of the present disclosure, an apparatus for use as a wheelchair chassis may include the first side frame and the second side frame each having a forward and a rearward terminus. The first receiver tube may be substantially centered between the first side frame forward terminus and the first side frame rearward terminus. The second receiver tube may be substantially centered between the second side frame forward terminus and the second side frame rearward terminus. The apparatus may additionally include the first and second extension tubes having a forward terminus and a rearward terminus. The first extension tube rearward terminus may be telescopically engaged with the first receiver tube, while the first extension tube forward terminus extends toward the first side frame forward terminus. Similarly, the second extension tube rearward terminus may be telescopically engaged with the second receiver, while the second extension tube forward terminus extends toward the second side frame forward terminus.

### BRIEF DESCRIPTION OF THE DRAWINGS

A more complete and thorough understanding of the presently disclosed embodiments and advantages thereof may be acquired by referring to the following description taken in conjunction with the accompanying drawings, in which like reference numbers indicate like features, and wherein:

FIG. 1 is a perspective view of an embodiment of the present disclosure, in which the wheelbase dimension is at or near its maximum.

FIG. 2 is a perspective view of an embodiment of the present disclosure, in which the wheelbase dimension is at or near its minimum.

FIG. 3 is a top plan view of an embodiment of the present disclosure, in which the wheelbase dimension is at or near its maximum.

FIG. 4 is a top plan view of an embodiment of the present disclosure, in which the wheelbase dimension is at or near its minimum.

### DETAILED DESCRIPTION OF THE INVENTION

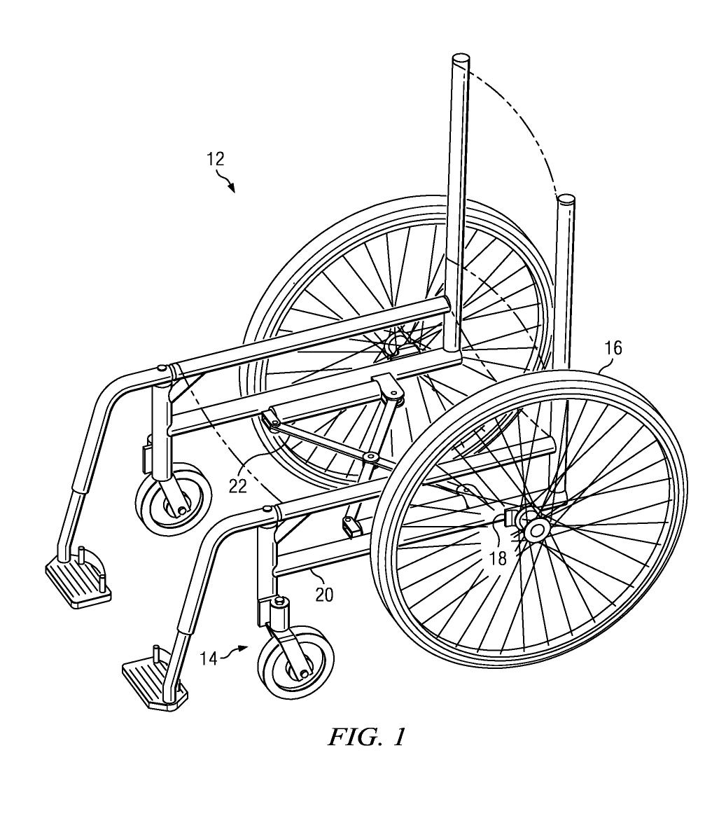

Preferred embodiments of the invention and its advantages are best understood by reference to FIGS. 1-4, wherein like numbers refer to the same and like parts.

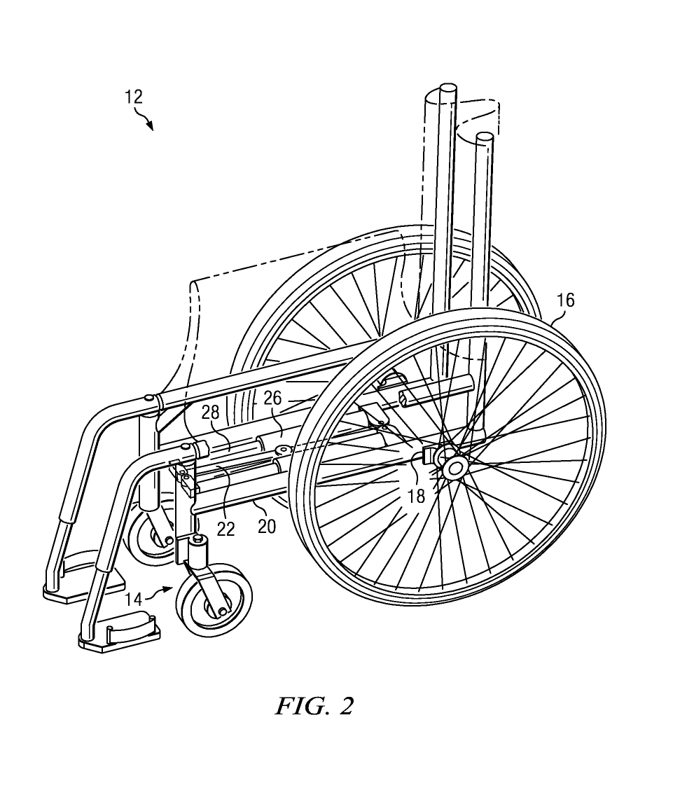

Referring to FIGS. 1 and 2, the wheelchair chassis of the present disclosure is identified by the reference numeral 12. The wheelchair chassis 12 will be used to demonstrate the present disclosure, but it is to be understood that the present disclosure has utility in fields quite unrelated to wheelchairs.

Referring primarily to FIGS. 1 and 2, the wheelchair chassis 12 may include two side frames 20. In some embodiments, the wheelchair chassis 12 may also include two axle blocks 18, each of which may be rigidly coupled to one of the two side frames 20. A primary wheel 16 may be attached to each of the two axle blocks 18, while a caster wheel assembly 14 may be coupled proximate to the forward terminus of each of the side frames 20.

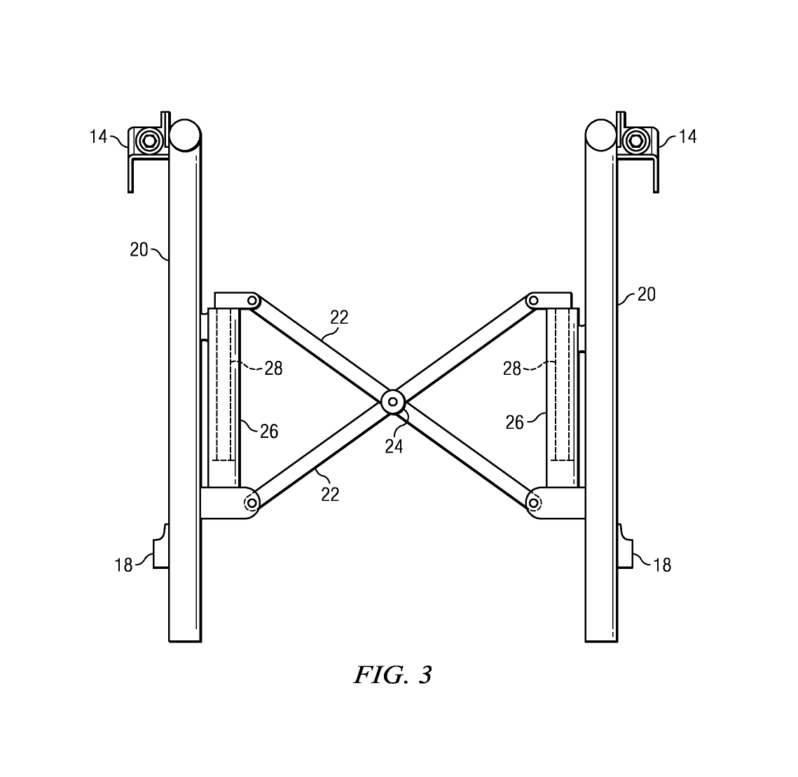

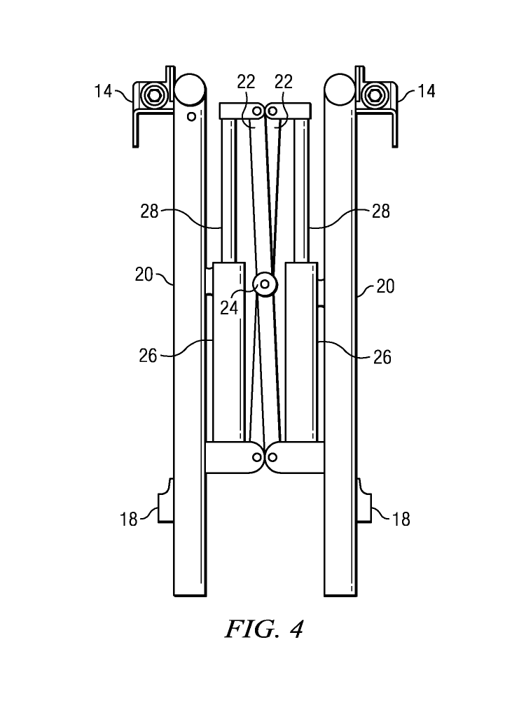

Referring primarily to FIGS. 3 AND 4, the wheelchair chassis 12 may also include two receiver tubes 26. In some embodiments, the side frames 20 may be rigidly coupled to the receiver tubes 26. Each receiver tube 26 may be positioned substantially parallel to one of the two side frames 20. Additionally, each receiver tube 26 may be substantially centered between the forward and rearward terminus of the corresponding side frame 20.

It will be understood by one of skill in the art that the term tube as used to refer to receiver tubes 26 and extension tubes 28 is not limited to an element of circular cross-section. As commonly used in the art, the term tube describes a hollow, elongated body with a polygonal or elliptical cross-section. Thus, the term tube may refer to an element with a cross-section that is circular, elliptical, square, rectangular, triangular, etc.

Wheelchair chassis 12 may also include two extension tubes 28, each of which may be telescopically engaged with a corresponding receiver tube 26. In some embodiments, the rearward terminus of each extension tube 28 may be telescopically engaged with the corresponding receiver tube 26, while the forward terminus of each extension tube 28 may extend toward the forward terminus of the corresponding side frame 20.

Wheelchair chassis 12 may additionally include two cross members 22. Each of the cross members 22 may be pivotally coupled to one of the receiver tubes 26 and one of the extension tubes 28, such that the two cross members 22 are arranged in an X-shaped configuration. In some embodiments, the cross members 22 may be coupled in an X-shaped fashion such that each cross member 22 is coupled to the rearward terminus of one of the receiver tubes 26 and the forward terminus of one of the extension tubes 28. In addition, or alternatively, the cross members 22 may intersect at a hub 24. The cross-members 22 may pivot about the hub 24 in a scissor-like manner as the width of the wheelchair chassis 12 is adjusted. In these and other embodiments, the hub 24 may be substantially equidistant from the two side frames 20 and from the forward and rearward termini of the two side frames 20. In this configuration, the hub 24 is substantially centered within the wheelchair chassis 12, rather than positioned toward the rear of the chassis as in U.S. Pat. No. 5,782,483.

With reference primarily to FIGS. 3 and 4, it can be appreciated how the wheelchair chassis 12 may operate to contract and expand the wheelbase dimension by decreasing and increasing the width between side frames 20. When the wheelbase dimension of the wheelchair chassis 12 is at its maximum, each extension tube 28 may be fully engaged within the corresponding receiver tube 26. To reduce the wheelbase dimension of the wheelchair chassis 12, the side frames 20 may be drawn closer together through the application of a compressive force. This compressive force may cause the cross members 22 to pivot about the hub 24 in a scissor-like manner, thereby reducing the width between the side frames 20. As the cross members 22 pivot about the hub 24, the forward terminus of each extension tube 28 may move toward the forward terminus of the corresponding side frame 20. As a result, the portion of each extension tube 28 disposed within the corresponding receiver tube 26 may be reduced. The reverse operation (i.e., applying expansive force to the side frames 20) may have the reverse effect on the wheelbase dimension of the wheelchair chassis 12.

Some embodiments may include a caster locking mechanism (not shown in the drawings), which may be used in the event that a user of wheelchair chassis 12 lacks the strength to effect an adequate compressive or expansive force to contract or expand the wheelbase dimension of the wheelchair chassis 12. Through the use of an actuator, the caster locking mechanism may be caused to effect a “toe-in” orientation of the caster wheel assemblies 14. When so actuated, forward motion of wheelchair chassis 12 will necessarily effect a contraction of the wheelbase dimension of wheelchair chassis 12, and rearward motion will effect the converse.

Notwithstanding the dynamics of the compressive and expansive forces required to contract and expand the wheelbase dimension of the wheelchair chassis 12, side frames 20 may remain securely linked and the structural integrity of wheelchair chassis 12 is not changed. Because both the forward and rearward termini of receiver tubes 26 may be rigidly coupled to side frames 20, cross members 22 may move pivotally in a single plane. The pivotal motion of cross members 22 may thus permit easy, on-the-fly contraction and expansion of the wheelbase dimension of wheelchair chassis 12 while supporting the side frames 20 in the desired, parallel orientation shown in all the figures. Without this support, the side frames 20 would tend to collapse under the torque applied by the weight of a rider. No other known wheelchair design affords these capabilities simultaneously.

The torque applied by the weight of the rider may be further counteracted by the positioning of the hub 24, which may be substantially centered within wheelchair chassis 12. In this configuration, the torque applied by the weight of the rider may be equally distributed from front to back, which may reduce the tendency of the forward termini of the side frames 20 to toe-in toward the center of the chassis.

Wheelchairs of known designs either expand and contract in increments effected by complex and semi-permanent adjustments or provide very unstable chassis characteristics. To the applicant's knowledge, only the present disclosure provides a stable, easy to use wheelchair with on-the-fly adjustment of wheelbase dimensions.

Although the present disclosure has been described with reference to specific embodiments, this description is not meant to be construed in a limited sense. It is important to note that the present disclosure has application beyond the field of wheelchairs. The vehicle chassis described herein could be incorporated into any number of wheeled vehicles, carts, automobiles, and/or other equipment for which it would be advantageous to provide an adjustable wheelbase.

One example of an application of the present disclosure which is extremely far afield of the wheelchair art would be that of an industrial crane. An expansive wheelbase is desirable for most cranes, but the wheelbase dimensions are quite limited for vehicle-based cranes which must travel by roadways. The traditional solution for providing an industrial crane with a more stable base is to use outriggers. But outriggers impede ready movement of the crane once they are extended. Use of the disclosed vehicle chassis design would address this problem by permitting on-the-fly adjustment of wheelbase dimensions, which could be expanded for stability and contracted for mobility.

Additionally, the vehicle chassis of the present disclosure could be incorporated into a three-wheeled vehicle. One version of such a vehicle (not shown in the drawings) might exhibit extension tubes 28 which converge to join with a single caster wheel assembly 14. Provided that a sufficient length of the extension tubes 28 remain straight before convergence, normal interaction between the extension tubes 28 and receiver tubes 26 would be enabled and the same pivoting motion of cross members 22 as described herein would be possible.

Additionally, it should be understood that various changes, substitutions and alternations can be made herein without departing from the spirit and scope of the invention as defined by the following claims.

1. An apparatus comprising:
a first side frame member having a first side frame member forward terminus and a first side frame member rearward terminus;
a second side frame member having a second side frame member forward terminus and a second side frame member rearward terminus, wherein the second side frame member is positioned substantially co-planar with and substantially parallel to the first side frame member at a width apart from the first side frame member;
a first receiver tube coupled to the first side frame member, the first receiver tube being closed at one end, wherein the first receiver tube is and positioned substantially co-planar with and substantially parallel to the first side frame member;
a second receiver tube coupled to the second side frame member, the second receiver tube being closed at one end and positioned substantially co-planar with and substantially parallel to the second side frame member;
a first extension tube, wherein the first extension tube is telescopically engaged with the first receiver tube;
a second extension tube, wherein the second extension tube is telescopically engaged with the second receiver tube;
a first cross member pivotally coupled to the first receiver tube and the second extension tube; and
a second cross member pivotally coupled to the second receiver tube and the first extension tube, the second cross member engaged to the first cross member in an X-shaped configuration disposed horizontally between the first side frame member—and the second side frame member, the second cross member substantially co-planar with the first cross member.

2. The apparatus of claim 1, further comprising:
the first receiver tube being substantially centered between the first side frame member forward terminus and the first side frame member-rearward terminus; and
the second receiver tube being substantially centered between the second side frame member-forward terminus and the second side frame member-rearward terminus.

3. The apparatus of claim 1, further comprising:
the first extension tube having a first extension tube forward terminus and a first extension tube rearward terminus, wherein the first extension tube rearward terminus is telescopically engaged with the first receiver tube, while the first extension tube forward terminus extends toward the first side frame member-forward terminus; and
the second extension tube having a second extension tube forward terminus and a second extension tube rearward terminus, wherein the second extension tube rearward terminus is telescopically engaged with the second receiver tube, while the second extension tube forward terminus extends toward the second side frame member-forward terminus.

4. The apparatus of claim 1, further comprising:
the first extension tube being fully engaged within the first receiver tube when the width is at a maximum; and
the second extension tube being fully engaged within the second receiver tube when the width is at a maximum.

5. The apparatus of claim 1, further comprising:
the first receiver tube having a first receiver tube forward terminus and a first receiver tube rearward terminus; and
the second receiver tube having a second receiver tube forward terminus and a second receiver tube rearward terminus, wherein:
the first cross member is coupled to the first receiver tube rearward terminus and the second extension tube forward terminus; and
the second cross member is coupled to the second receiver tube rearward terminus and the first extension tube forward terminus.

6. The apparatus of claim 1, wherein the first cross member engages the second cross member at a point of intersection.

7. The apparatus of claim 6, further comprising a hub at the point of intersection, the first cross member and the second cross member operable to pivot about the hub in a scissor-like configuration as the width changes.

8. The apparatus of claim 6, wherein the hub is substantially centered in an area created by the first side frame member-forward terminus, the first side frame member-rearward terminus, the second side frame member-forward terminus, and the second side frame member-rearward terminus when the width is at or near a maximum.

9. The apparatus of claim 1, further comprising:
a first axle block coupled proximate to the first side frame member-rearward terminus;
a first primary wheel coupled proximate to the first axle block;
a second axle block coupled proximate to the second side frame member-rearward terminus;
a second primary wheel coupled proximate to the second axle block;
a first caster wheel assembly coupled proximate to the first side frame member-forward terminus; and
a second caster wheel assembly coupled proximate to the second side frame member forward terminus.

10. (canceled)

11. The apparatus of claim 1, wherein at least one of the first receiver tube and the second receiver tube has an elliptical cross-section.

12. The apparatus of claim 1, wherein at least one of the first receiver tube and the second receiver tube has a polygonal cross-section.

13. The apparatus of claim 1, wherein at least one of the first extension tube and the second extension tube has an elliptical cross-section.

14. The apparatus of claim 1, wherein at least one of the first extension tube and the second extension tube has a polygonal cross-section.

15. The apparatus of claim 1, wherein the apparatus comprises a wheelchair chassis.

16. The apparatus of claim 1, wherein the apparatus comprises a wheeled vehicle chassis.
